(19) United States
(12) Patent Application Publication
(10) Pub. No.: US 2017/0092445 A1
(43) Pub. Date: Mar. 30, 2017

(54) Type of one-piece microswitch with built-in resistor(s)

(71) Applicants: Hua ZHANG, Guangdong (CN); Daijun LU, Guangdong (CN)

(72) Inventors: Hua ZHANG, Guangdong (CN); Daijun LU, Guangdong (CN)

(21) Appl. No.: 15/275,489

(22) Filed: Sep. 26, 2016

(30) Foreign Application Priority Data
Sep. 28, 2015 (CN) 201520764855.1

(51) Int. Cl. H01H 15/18

(52) U.S. Cl. CPC H01H 15/18

(57) ABSTRACT

A type of one-piece microswitch with built-in resistor(s) having a switch casing, a button on the switch casing, with a pedestal located in the casing, a common terminal, a first terminal and a second terminal installed for connection to external circuits with the common terminal electrically connected to the first contact, the first and the second terminals electrically connected to the second contact respectively. The common terminal is connected to the first and/or second terminal via one or more resistors with a switching device used for switchover of connection or disconnection between the first and the second contacts. The button and pedestal are connected by a spring piece or spring. The switching device is installed on the button, which constitutes a linkage with the button.

### BACKGROUND OF THE INVENTION

The utility model relates to the field of switch, and in particular to a type of one-piece microswitch with built-in resistor(s).

Microswitches are widely applied in control equipment in such industries as machinery, electronics and medical treatment. According to the market research results, as to the microswitch products, higher requirements on micromation, high density, modularization and light weight, are raised not only for military use such as modern high-tech aviation, weaponry and electronic communication equipment, but also in electric fields for civil use, not just on the on-off action of the single unit any more. At present, the research and development on microswitch products in China is scattered and disordered. And the product performance is quite poor. When required to use together with resistor(s), the switch and resistor(s) are welded on the circuit board to realize signals switching via one or more resistors of different size. But the cost for circuit board is high; its production pollutes environment and the microswitch and auxiliary resistor(s) occupy a large space.

### BRIEF SUMMARY OF THE INVENTION

The utility model is designed to overcome the shortcomings in the prior art and provide a type of one-piece microswitch with built-in resistor(s), saving both space and cost.

The purpose of the utility model is accomplished with the technical proposal below:

A type of one-piece microswitch with built-in resistor(s), comprising a switch casing, a button installed on the switch casing, with a pedestal installed in the switch casing, the common, first and second terminals located on the pedestal to electrically connect with external circuits, a first contact electrically connected to the common terminal, a second contact electrically connected to the first terminal and the second terminal respectively. It has following characteristics: the common terminal is connected to the first and/or second terminal via one or more resistors with a switching device used for switchover of connection or disconnection between the first and the second contacts; the button and pedestal are connected by a spring piece or spring; the switching device is installed on the button, which constitutes a linkage with the button.

In the above structure, the said switching device and button constitute a linkage, while the first contact is always electrically connected to the common terminal and the second contact is electrically connected or disconnected to the first and/or the second terminals through the linkage with the button to meet practical circuit control requirements.

Optionally, one or more resistors can be installed between the first and the second terminals.

Specifically, the said switching device is a slider.

Specifically, the said resistor is a chip resistor or a plug-in resistor.

Compared with the prior art, the utility model has following advantages and beneficial effects:

The utility model, by installing the resistor needing type conversions directly in the switch casing of the microswitch, can realize the same function with the prior circuit board omitted, which greatly saves space and cost, makes the microswitch easier to use and satisfies its requirements for micromation, high density, modularization and light weight.

### BRIEF DESCRIPTION OF THE DRAWINGS

FIG. 1 is a structure diagram of the one-piece microswitch with built-in resistor(s).

FIG. 2 is an electric schematic diagram of the one-piece microswitch with built-in resistor(s).

### DETAILED DESCRIPTION OF THE INVENTION

Hereinafter, an embodiment and figures will be illustrated to further elaborate the utility model. But the embodiments of the utility model are not limited to this.

### Embodiment 1

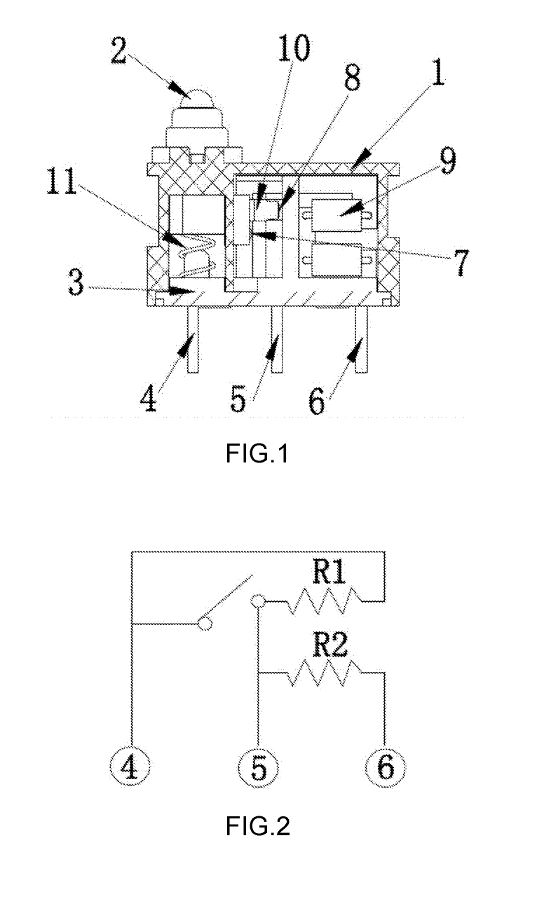

As shown in FIG. 1 and FIG. 2, this embodiment provides a type of one-piece microswitch with built-in resistor(s) comprising a switch casing (1), a button (2) installed on the switch casing (1), with a pedestal (3) installed in the switch casing (1), three terminals installed on the pedestal (3) used to connect to the external circuits, namely, a common terminal (4), a first terminal (5) and a second terminal (6), a first contact (7) electrically connected to the common terminal (4), a second contact (8) electrically connected to the first terminal (5) and the second terminal (6) separately. The said common terminal (4) is connected to the first terminal (5)and/or second terminal (6) via one or more resistors (9) with a switching device (10) used for switchover of connection or disconnection between the first contact (7)and the second contact (8); the said button (2) and pedestal (3) are connected by a spring piece or spring (11); the said switching device (10) is installed on the button (2), which constitutes a linkage with the button (2). In the above structure, the switching device and the button constitute a linkage, while the first contact is always electrically connected to the common terminal and the second contact is electrically connected or disconnected to the first terminal and/or the second terminal through the linkage with the button to meet practical circuit control requirements.

Alternatively, one resistor or more resistors are installed between a first terminal (5) and a second terminal (6). In a specific application, if resistors of other types are needed for the signal control, it can be realized by changing the shapes of a first terminal (5) and a second terminal (6) or the way these terminals are connected and increasing or decreasing the resistance to satisfy the control function requirement and the performance requirement.

In this embodiment, switching device (10) is a slider. During the linkage process with the button, it can realize the connection or disconnection between the first contact (7) and the second contact (8) via a slider.

In order to make an easy installation and meet the practical needs, the resistor (9) is a chip resistor or a plug-in resistor.

It should be noted that the resistor(s) in this utility model is/are specifically arranged in the microswitch according to the specific circuit control or signal control and the slider contact of the microswitch can make the first contact (7) and the second contact (8) connected with a slider or snap. By improving the traditional structure of the available button to combine the control circuit and the mechanical switch and installing resistors needing type conversions directly in the switch casing of the microswitch, identical function can be realized with the prior circuit board omitted, which greatly saves space and cost, making the microswitch easier to use and satisfying the requirements of microswitch for micromation, high density, modularization and light weight.

The embodiment above is a preferred embodiment of the utility model. Yet the embodiment of the utility mode is not restricted by the given embodiment. Any other alternations, modifications, replacements, combinations and simplifications made without deviations from the spiritual essence and principle of the utility model can be equivalent replacements and are covered in the scope of protection for the utility model.

What is claimed is:

1. A type of one-piece microswitch with built-in resistor(s), comprising a switch casing, a button installed on the switch casing, with a pedestal installed in the switch casing, the common, first and second terminals located on the pedestal to electrically connect with external circuits, a first contact electrically connected to the common terminal, a second contact electrically connected to the first terminal and the second terminal respectively. It has following characteristics: the common terminal is connected to the first and/or second terminal via one or more resistors with a switching device used for switchover of connection or disconnection between the first and the second contacts; the button and pedestal are connected by a spring piece or spring; the switching device is installed on the button, which constitutes a linkage with the button.

2. The one-piece microswitch with built-in resistor(s) as said in claim 1, is characterized in that one or more resistors is, or are installed between the first and second terminals.

3. The one-piece microswitch with built-in resistor(s) as said in claim 1, wherein, the said switching device is a slider.

4. The one-piece microswitch with built-in resistor(s) according to claim 1, wherein, the said resistor is a chip or plug-in resistor.
